(19) United States
(12) Patent Application Publication
(10) Pub. No.: US 2026/0165378 A1
(43) Pub. Date: Jun. 18, 2026

(54) HEATER FOR AN AEROSOL PROVISION DEVICE

(71) Applicant: Nicoventures Trading Limited, London (GB)

(72) Inventors: Tom WOODMAN, London (GB); Juan Esteban PAZ JAUREGUI, London (GB)

(21) Appl. No.: 19/125,206

(22) PCT Filed: Oct. 30, 2023
(86) PCT No.: PCT/EP2023/080281

§ 371 Date: Apr. 28, 2025

(30) Foreign Application Priority Data
Oct. 31, 2022 (GB) 2216091.5

(51) Int. Cl. A24F 40/46; H05B 3/34; H05B 3/46

(52) U.S. Cl. CPC A24F 40/46; H05B 3/34; H05B 3/46

(57) ABSTRACT

A heater for an aerosol provision device configured to heat an article containing aerosol generating material is disclosed. The heater includes an elongate housing having a longitudinal axis and a heating element comprising a continuous length of heating material. The continuous length of heating material follows a serpentine path.

### CROSS-REFERENCE TO RELATED APPLICATIONS

This present application is a National Phase entry of PCT Application No. PCT/EP2023/080281, filed Oct. 30, 2023, which claims priority from GB Application No. 2216091.5, filed Oct. 31, 2022, each of which are fully incorporated herein by reference in their entireties.

### TECHNICAL FIELD

The present invention relates to a heater for an aerosol provision device, an aerosol provision device, an aerosol provision system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately, induction heating systems are known to be used as heaters.

### SUMMARY

According to an aspect there is provided a heater for an aerosol provision device configured to heat an article containing aerosol generating material, in which the heater comprises: an elongate housing having a longitudinal axis and a heating element comprising a continuous length of heating material. The continuous length of heating material follows a serpentine path. It is to be understood that a serpentine path is a non-linear path comprising one or more changes in the direction of a centreline of the path.

The serpentine path may comprise two or more changes in direction.

The continuous length of heating material may comprise a plurality of portions of the length and a plurality of intersections, the intersections extend between longitudinally adjacent portions, and the portions and the intersections alternate along the length of the heating material. All the portions and intersections may form part of the single continuous length of the heating material.

Each of the portions may be straight, and each portion extends at least partially in a direction parallel to the longitudinal axis of the elongate housing.

Each of the portions may be curved, and each portion extends at least partially in a direction parallel to the longitudinal axis of the elongate housing.

At least one of the portions may be straight, at least one of the portions is curved. Each portion may extend at least partially in a direction parallel to the longitudinal axis of the elongate housing.

At least one intersection may be a curved link extending between the longitudinally adjacent ends of adjacent portions of the length of the heating material. The length of the curved link may be less than the length of either of the portions between which the curved link extends.

At least one intersection may be comprised of a straight link extending between the longitudinally adjacent ends of adjacent portions of the length of the heating material. The length of the straight link may be less than the length of either of the portions between which the straight link extends.

The length of the length of the straight or curved link may be at least 50%, at least 60%, at least 70%, at least 80% or at least 90% less than the length of either of the portions between which the straight or curved link extends.

At least one intersection may be so configured that the included angle between the projected longitudinal axes of the part of the longitudinally adjacent portions that intersect the intersection which is between the adjacent portions is greater than or equal to 0 degrees and less than or equal to 45 degrees.

At least one intersection may be so configured that the included angle between the projected longitudinal axes of the part of the longitudinally adjacent portions that intersect the intersection which is between the adjacent portions is greater than 45 degrees and less than or equal to 90 degrees.

Each intersection may have the same configuration.

Each intersection may be so configured that the included angle between the projected longitudinal axes of the part of the longitudinally adjacent portions that intersect the intersection which is between the adjacent portions is one of 0 degrees, 45 degrees and 90 degrees.

The heater may comprise a substrate. At least part of the continuous length of heating material may be supported on a surface of the substrate.

The continuous length of heating material may be an electrically resistive material. The heater may be a resistive heater.

The housing has a base end and a free end. The free end may be configured to penetrate the article containing aerosol generating material.

The continuous length of heating material may have a first and second end. The intersection longitudinally closest to the first end of the continuous length of heating material and the intersection longitudinally closest to the second end of the continuous length of heating material may both be closer to the free end of the housing than the base end of the housing. In this context longitudinally references the continuous length of heating material.

The housing may define a longitudinally extending bore. The base end of the housing may define an open end of the bore. At least a part of the continuous length of heating material may be located within the bore.

At least 50%, at least 60%, at least 70%, at least 80%, at least 90%, or 100% of the continuous length of heating material is located within the bore.

The heater further may comprise at least one mass of a material. The at least one mass may be so configured that retains at least part of the continuous length of heating material in a fixed position relative to the housing.

The mass of material may be so configured that the whole of the continuous length of heating material is retained in a fixed position relative to the housing.

The mass of material may be an adhesive or a potting compound.

The heater may be an inductive heating heater.

The continuous length of heating material may be an inductive heating element.

According to an aspect, there is provided aerosol provision device configured to heat an article comprising aerosol generating material, the device comprising a heater described above.

The aerosol provision device may comprise a heating chamber, in which the heater is provided.

The aerosol provision device may comprise a power source, a controller and a heating chamber, in which the aerosol generating article is removeable received.

The power source may be aligned along a longitudinal axis of the heating chamber.

The power source may be aligned along a second longitudinal axis, parallel to the longitudinal axis of the heating chamber.

The aerosol provision device may be configured for wireless charging.

The aerosol provision device may be provided with a charging port, such as a USB port, which is used to couple the power supply to an external power source for recharging.

According to an aspect there is provided an aerosol provision system comprising: an aerosol provision device as described above; and an article comprising aerosol generating material.

The aerosol provision system may comprise a charging unit having a cavity for removably receiving the aerosol provision device.

The charging unit may comprise a moveable lid, which covers the aerosol provision device in a closed configuration.

The charging unit may comprise a user display.

The user display may be visible to a user when the moveable lid is in a closed position and is partially or fully concealed or obscured from sight by the lid when the lid is an open position.

According to another aspect there is provided a method of generating aerosol comprising: providing an aerosol provision device comprising a heater as described above and a heating chamber including a receiving portion; and at least partially inserting an aerosol generating article into the receiving portion of the heating chamber.

The heating and device aspects of the present disclosure can include one or more, or all, of the features or embodiments described above, as appropriate. The method aspect of the present disclosure can include one or more, or all, of the features or embodiments described above, as appropriate.

### BRIEF DESCRIPTION OF THE DRAWINGS

Various embodiments will now be described, by way of example only, and with reference to the accompanying drawings, in which:

FIG. 1 shows a perspective view of an embodiment of an aerosol provision system including an embodiment of an aerosol provision device located within a charging unit;

FIG. 2 shows a schematic cross-sectional view of part of the aerosol provision device of FIG. 1;

FIG. 3 shows a schematic cross-sectional view of part of the aerosol provision device of FIG. 1 and an aerosol generating article of the aerosol provision system;

FIG. 4 shows a perspective view of another aerosol provision device;

FIG. 5 shows a schematic cross-sectional view of the device of FIG. 4;

FIG. 6 shows a schematic cross-sectional view of an embodiment of a heater of the device of FIG. 1 or FIG. 4;

FIG. 7 shows a detail of a first embodiment of a heater member of the heater of FIG. 6;

FIG. 8 shows a first detail of a second embodiment of a heater member of the heater of FIG. 6;

FIG. 9 shows a second detail of the second embodiment of a heater member of the heater of FIG. 6;

FIG. 10 shows a detail of a third embodiment of a heater member of the heater of FIG. 6; and

FIG. 11 shows a detail of a second embodiment of a heater member of the heater of FIG. 6.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area or volume for receiving the consumable, an aerosol generator, an aerosol generation area or volume, a housing, a mouthpiece, a filter and/or an aerosol-modifying agent.

In some embodiments, the consumable for use with the non-combustible aerosol provision device may comprise aerosol-generating material, an aerosol-generating material storage area or volume, an aerosol-generating material transfer component, an aerosol generator, an aerosol generation area or volume, a housing, a wrapper, a filter, a mouthpiece, and/or an aerosol-modifying agent.

As used herein, the term “aerosol-generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourant.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

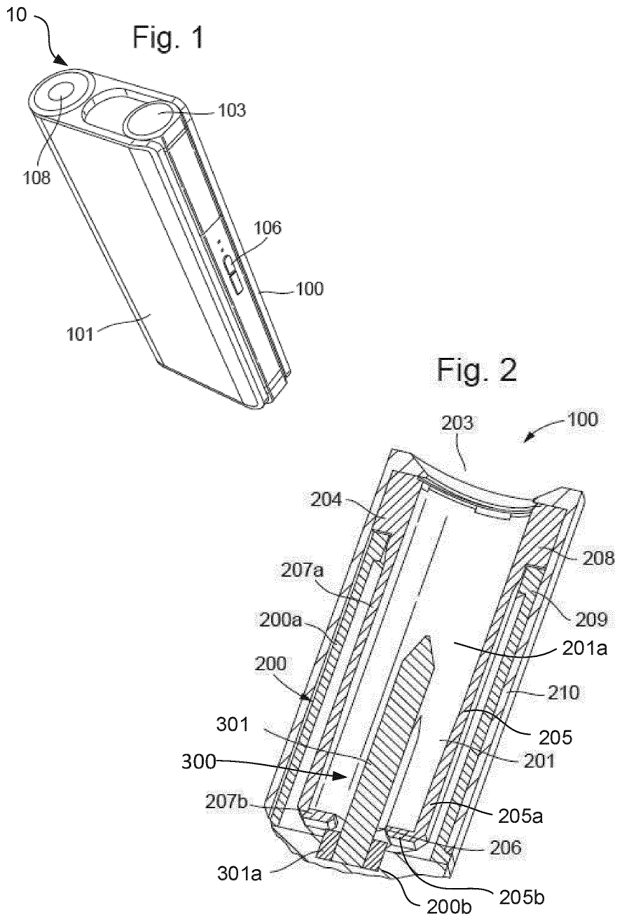

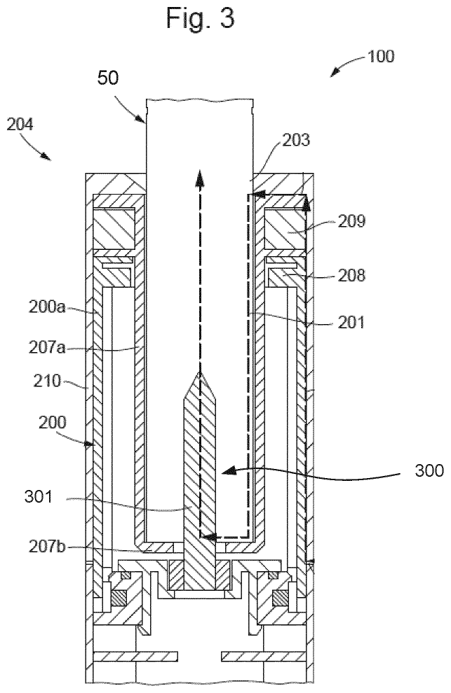

FIG. 1 shows an aerosol provision system 10 comprising an aerosol provision device 100 and a charging unit 101. The device is shown located within a cavity of a charging unit 101. The aerosol provision device 100 is arranged to generate aerosol from an aerosol generating article (refer to FIG. 3) which may be inserted, in use, into the aerosol provision device 100. In embodiments, the article forms part of the aerosol provision system 10.

The aerosol provision device 100 is an elongate structure, extending along a longitudinal axis. Additionally, the aerosol provision device has a proximal end, which will be closest to the user (e.g. the user's mouth) when in use by the user to inhale the aerosol generated by the aerosol provision device 100, as well as a distal end which will be furthest from the user when in use. The proximal end may also be referred to as the “mouth end”. The aerosol provision device 100 also accordingly defines a proximal direction, which is directed towards the user when in use. Further, the aerosol provision device 100 also likewise defines a distal direction, which is directed away from the user when in use. The terms proximal and distal as applied to features of the device 100 will be described by reference to the relative positioning of such features with respect to each other in a proximal-distal direction along a longitudinal axis. The aerosol provision device 100 comprises an opening at the distal end, leading into a heating chamber.

The aerosol provision device 100 may be removably inserted into the charging unit 101 in order to be charged. The charging unit 101 comprises a cavity (refer to FIG. 2) for receiving the aerosol provision device 100. The aerosol provision device 100 may be inserted into the cavity via an opening. The cavity may also comprise a longitudinal opening. A portion of the aerosol provision device 100 may comprise a first side. One or more user-operable control elements such as buttons 106 which can be used to operate the aerosol provision device 100 may be provided on the first side of the aerosol provision device 100. The first side of the aerosol provision device 100 may be received in the longitudinal opening provided in the charging unit 101.

In embodiments the cavity of the charging unit 101 may have a cross-sectional profile which only permits that the aerosol provision device 100 be inserted into the charging unit 101 in a single orientation. According to an embodiment the outer profile of the aerosol provision device 100 may comprise an arcuate portion and a linear portion. The cross-sectional profile of the cavity provided in the charging unit 101 may also comprise a similar arcuate portion and a linear portion. The linear portion of the cross-sectional profile of the cavity may correspond with the longitudinal opening.

The charging unit 101 includes a slidable lid 103. When the aerosol provision device 100 is inserted into the charging unit 101 in order to be recharged, the slidable lid 103 may be closed so as to cover the opening into the aerosol provision device 100. In other embodiments, the charging unit 101 may have an alternative lid configuration, such as a hinged or pivoted lid, or no lid may be provided.

The charging unit 101 may include a user interface such as display 108, which can be provided at any convenient location, such as in the position shown in FIG. 1.

FIG. 2 shows a cross sectional view of a portion of the aerosol provision device 100. The aerosol provision device 100 comprises a main housing 200. The main housing 200 defines a device body of the device 100. The device 100 defines a heating chamber 201. A receptacle 205 defines the heating chamber 201. An opening 203 is provided to provide access to the heating chamber 201. The receptacle 205 comprises a wall arrangement including a receptacle side wall 205a and a receptacle base 205b. The base 205b is at the distal end of the receptacle 205. A heating zone 201a is configured to receive at least a portion of the article for heating.

A heater 301 is provided in a portion of the main housing 200 and the heater 301 extends or projects into the heating chamber 201. The heater 301 may comprise a base portion 301a which may be located in a recess provided in a portion of the body of the device 100. The heater 301 upstands in the heating chamber 201. The heater 301 upstands from the distal end.

The heater 301 comprises an elongate heating member in the form of a pin. The heater 301 in other embodiments comprises other elongate configurations, such as a blade. The heater 301 may be inserted, in use, into a distal end of an aerosol generating article 50 (refer to FIG. 3) which is received within the heating chamber 201 in order to internally heat the aerosol generating article.

The housing comprises housing wall 200a. The housing wall 200a extends parallel to the longitudinal axis of the aerosol provision device 100, surrounding the heating chamber 201. The housing wall 200a may, at least in part, define a receiving chamber of the aerosol provision device 100, as the volume which is enclosed within the wall 200a. A housing base 200b is at the distal end of the housing wall 200a. In the shown embodiment, the heater 301 upstands from the housing base 200b. The heater 301 protrudes through the receptacle base 205b. An aperture 206 is formed in the receptacle base 205b through which the heater 301 protrudes. In embodiments, the heater 301 is mounted to the receptacle base 205b. The heater 301 upstands from the receptacle base 205b.

The aerosol provision device 100 further comprises a removal mechanism 204 which may be removably retained to the main housing 200 of the aerosol provision device 100. The removal mechanism 204 in embodiments is omitted. In embodiments, the housing wall 200a at least in part defines the receptacle 205. The removal mechanism 204 may be retained to the main housing 200 so that at least a portion of the removal mechanism 204 extends into the heating chamber 201. The removal mechanism 204 may comprise a longitudinal portion such as a peripheral wall portion 207a, which in the present embodiment is tubular, and a base wall portion 207b. The wall 207a may be a shape other than tubular, and may be any shape which encloses (e.g. encircles) and defines the heating chamber 201 there within.

In embodiments with the removal mechanism 204, the removal mechanism 204 defines the heating chamber 201. The removal mechanism 204 forms the receptacle 205. In embodiments in which the removal mechanism 204 is omitted, other features of the device 100 define the heating chamber 201, for example the housing side wall 200a and housing base 200b.

The base portion 207b has the aperture 206 through which the heater 301 may project. In order to retain the removal mechanism 204 to the main housing 200, the removal mechanism 204 is pushed into engagement with the main housing 200 in the distal direction, i.e. towards the distal end of the main housing 200, until the removal mechanism 204 is able to move no further in the distal direction. In the following description, when the removal mechanism 204 is referred to as being “retained to” the main housing 200, this is when the removal mechanism 204 is engaged with the main housing 200, and can move no further in the distal direction.

Together, the peripheral portion 207a and the base portion 207b may define and enclose an article chamber for receiving the aerosol generating article 50, as shown in FIG. 3. The article chamber comprises an inner surface, which is configured to contact the aerosol generating article, the inner surface comprising a longitudinally extending portion which is provided by the tubular portion 207a, and an end portion which is provided by the base portion 207b. In embodiments, the article chamber and the heating chamber are the same. When the aerosol generating article 50 is received in the heating chamber, it may contact both the longitudinally extending portion of the inner surface, and the end portion of the inner surface. In particular, the article chamber (i.e. the peripheral portion 207a and the base portion 207b) may be configured to receive at least part of the aerosol generating article 50 which is in the form of a rod which is longitudinally extending and cylindrical, such that the longitudinal axis of the article is parallel to (and optionally in line with) the longitudinal axis of the aerosol provision device 100 when received in the article chamber.

The article chamber may also be referred to as a receiving portion. When the removal mechanism 204 is retained to the main housing 200, in use, the article chamber of the removal mechanism 204 is arranged, at least partially, within the heating chamber 201. The heater 301 may be arranged so as to project into the article chamber, through the aperture 206 provided in the base portion 207b of the removal mechanism 204. The removal mechanism 204 is therefore configured to receive at least a portion of the aerosol generating article in use.

In embodiments, the removal mechanism 204 may comprise a first magnet or a magnetisable material 208. The main housing 200 may comprise a second magnet or magnetisable material 209. In use, the removal mechanism 204 may be magnetically retained to the main housing 200 by the interaction of the first magnet or magnetisable material 208 and the second magnet or magnetisable material 209.

In embodiments, the removal mechanism 204 is fully detachable from the main housing 200. The removal mechanism 204 may be retained to the main housing 200 by a magnetic force of attraction between the first magnet or magnetisable material 208 and the second magnet or magnetisable material 209. The removal mechanism 204 may be detached from the main housing 200 by overcoming the magnetic force between the first magnet or magnetisable material 208 and the second magnet or magnetisable material 209. In embodiments, the removal mechanism 204 is removably retained to the main housing 200 by other means. For example, the removal mechanism 204 may be configured to be removably retained to the main housing 200 by an interference fit with the main housing.

The removal mechanism 204 may comprise an internal element (comprising the tubular portion 207a and a base portion 207b) and an outer cap portion 210, wherein when retained to the main housing 200 the outer cap portion 210 encapsulates (e.g. covers) at least a portion of the main housing 200, such as the wall 200a of the main housing. The tubular portion 207a, base portion 207b and outer cap portion 210 may comprise an integral (e.g. unitary) component (formed, for example, by moulding). Alternatively, the tubular portion 207a and base portion 207b may comprise a first component and the outer cap portion 210 may comprise a second separate component. The first and second components may then be secured together.

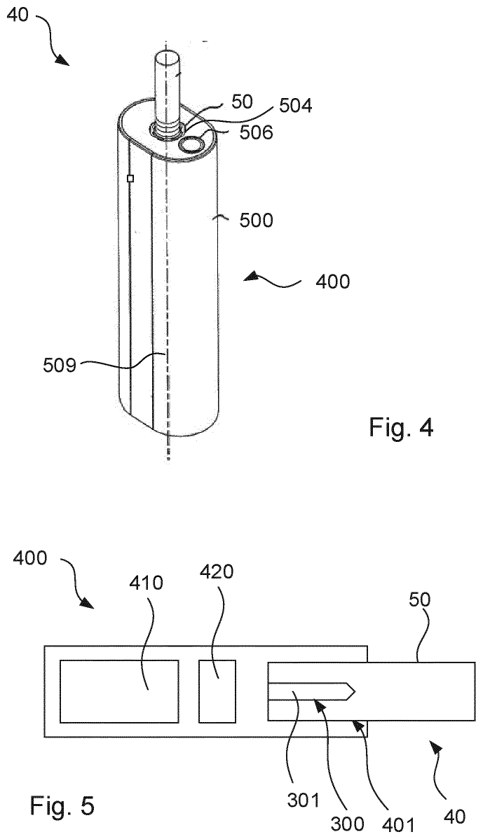

FIG. 4 shows another aerosol provision system 40. The system 40 comprises a one-piece aerosol provision device 400 for generating aerosol from an aerosol generating material, and the aerosol generating article 50 comprising the aerosol generating material. The device 400 can be used to heat the aerosol generating article 50 comprising the aerosol generating material, to generate an aerosol or other inhalable medium which can be inhaled by a user of the device 400.

The device 400 comprises a housing 500 which surrounds and houses various components of the device 400. The housing 500 is elongate. The device 400 has an opening 504 in one end, through which the article 50 can be inserted for heating by the device 400. The article 50 may be fully or partially inserted into the device 400 for heating by the device 400.

The device 400 may comprise a user-operable control element 506, such as a button or switch, which operates the device 400 when operated, e.g. pressed. For example, a user may activate the device 400 by pressing the switch 406.

The device 400 defines a longitudinal axis 509 along which an article 50 may extend when inserted into the device 400. The opening 504 is aligned on the longitudinal axis 509.

FIG. 5 shows a cross-sectional schematic view of the aerosol provision system 40. Features described with reference to FIG. 5 in embodiments are applicable to embodiments described above. The aerosol provision device 400 comprises a power source 410, a controller 420 and a heating chamber 401, in which the aerosol generating article 50 is removeable received.

The one-piece device of FIG. 5 shows the power source 410 aligned along the longitudinal axis of the heating chamber 401. In another embodiment of a one-piece aerosol generating device, the power source is aligned along a second longitudinal axis, parallel to the longitudinal axis of the heating chamber.

The heater 301 comprises an elongate heater in the form of a pin. The heater 301 in embodiments comprises other elongate configurations, such as a blade. The heater 301 is provided in the heating chamber. The heater 301 of FIG. 5 and the heater 301 described above with reference to FIGS. 1 to 3, such that details described herein may be applied to each. The heater 301 extends or projects into the heating chamber 401.

The heater 301 may be inserted, in use, into a distal end of the aerosol generating article which is received within the heating chamber 401 in order to internally heat the aerosol generating article.

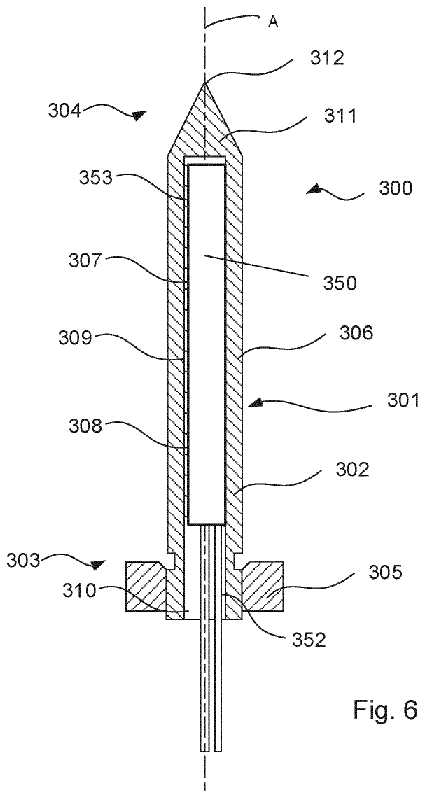

The aerosol provision devices 100, 400 comprise a heating arrangement 300. The heating arrangement 300 comprises a heater 301. The heater 301 comprises a heating element 350 (refer to FIG. 6), such as a length of resistive heating material, arranged to be actuated to heat the heater 301.

The heating arrangement 300 is a resistive heating arrangement. The heater is a resistive heating heater. The heating element, such as a heating coil, as will be described below is a resistive heating element. In such arrangements the heating assembly comprises a resistive heating generator including components to heat the heating element via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement comprises electrical contacts for supplying electrical current to the resistive material. In embodiments, the heating element forms at least part of the resistive heating member itself. In embodiments the resistive heating element transfers heat to the heating member, for example by conduction. The provision of a resistive heating arrangement allows for a compact arrangement. Resistive heating provides an efficient configuration.

FIG. 6 shows the heater 301 for use in an aerosol provision device as described above. The heating arrangement 300 comprises the heater 301. The heater 301 comprises an elongate housing 302 and the heating element 350. The elongate housing 302 is an elongate member defining a longitudinal axis A.

The housing 302 is formed from a thermally conductive material, such as aluminium. Other suitable materials, such as stainless steel or ceramic such as aluminium nitride may be used. The elongate housing may comprise a coating on its outer surface. The elongate housing 302 is configured to transfer heat from the heating element 350 to the heating zone 201a.

The elongate housing 302 has a base end 303 and a free end 304. The base end 304 mounts to the device body. A mount 305 at the base end 303 mounts the heater 301. It will be understood that different mounting arrangements may be used, for example a fixing, moulding, and bonding including adhering. The mount 305 may be a separate component or may be integrally formed with the elongate housing 302.

The elongate housing 302 comprises a housing body 306. The housing body 306 is tubular. The housing body 306 comprises a bore 307. The bore 307 defines an inner void 308 of the heater 301. The inner void 308 extends longitudinally in the direction of axis A. In embodiments, the inner void 308 is at least partially filled, for example with a filler. In embodiments, the inner void 308 is completely filled, for example with one or more fillers and/or components. In embodiments, the inner void 308 defines an air gap. An inner surface 309 is defined on an inner side of the elongate housing 302. An open end 310 to the inner void 308 is provided at the base end 303.

The free end 304 of the elongate housing 302 extends towards the proximal end of the heating chamber. The free end 304 of the heater 301 is closed. The inner void 308 does not extend through the free end 304. A tip 311 is provided at the free end 304. The tip 311 extends to an apex 312. Other shapes and configurations of the tip 311 may be provided, for example the tip 311 may define a planar surface.

The heating element 350 extends in the heater 301. The heating element 350 extends in the elongate housing 302 in the longitudinal direction. The heating element 350 is received in the inner void 308. The heating element 350 extends between the base end 303 and the distal end 304. In embodiments, the heating element extends partially along the length of the inner void 308. In embodiments the heating element 350 extends to or beyond the open end 310.

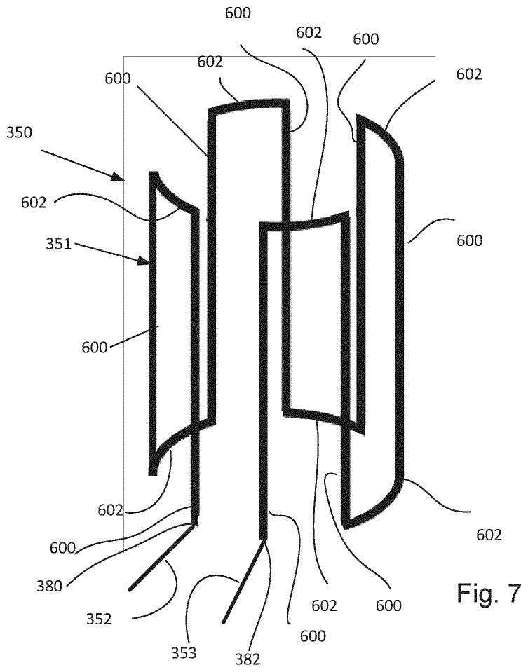

With reference to FIG. 7, a first embodiment of the heating element 350 comprises a continuous length of heating material 351 which follows a serpentine path. The continuous length of heating material 351 comprises a resistive member or restive heating material defining the continuous length of heating material 351. In embodiments the continuous length of heating material 351 comprises an electrically insulative coating, such as a ceramic or other dielectric material, to electrically insulate the continuous length of heating material 351 from the elongate housing 302. The electrically insulative coating in embodiments is thermally conductive to provide for heat transfer from the continuous length of heating material 350 to the elongate housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the continuous length of heating material 350 to the elongate housing 302.

The continuous length of heating material 351 is a resistive heater. The continuous length of heating material 351 comprises a plurality of portions 600 of the length and a plurality of intersections 602, the intersections 602 extend between longitudinally (with reference to the center line of the continuous length of heating material 351) adjacent portions 600, and the portions 600 and the intersections 602 alternate along the length of the heating material 351. All the portions and intersections form part of the single continuous length of the heating material.

In the embodiment shown in FIG. 7 each of the portions 600 is straight, and each portion 600 extends approximately in a direction parallel to the longitudinal axis A of the elongate housing 302. Each intersection 602 is a part of the continuous length of heating material 351 that extends between portions 600 that are, in terms of the centerline of the continuous length of heating material 351, longitudinally adjacent to each other. The intersections 602 extend at about a 90 degrees angle to the portions 600.

Each of the portions 600 are about parallel to each other and are so spaced from each other that they may be considered to be circumferentially spaced from each other around a circle in the plane perpendicular to all of the portions 600. That circle is so dimensioned that the continuous length of heating material 351 when configured into its serpentine path may sit within the inner void 308 of the housing 302.

In some alternative, non-illustrated embodiments, each of the portions 600 are curved, and each portion 600 extends at least partially in a direction parallel to the longitudinal axis A of the elongate housing 302.

In some alternative, non-illustrated embodiments, at least one of the portions 600 is straight, at least one of the portions 600 is curved, and each portion 600 extends at least partially in a direction parallel to the longitudinal axis.

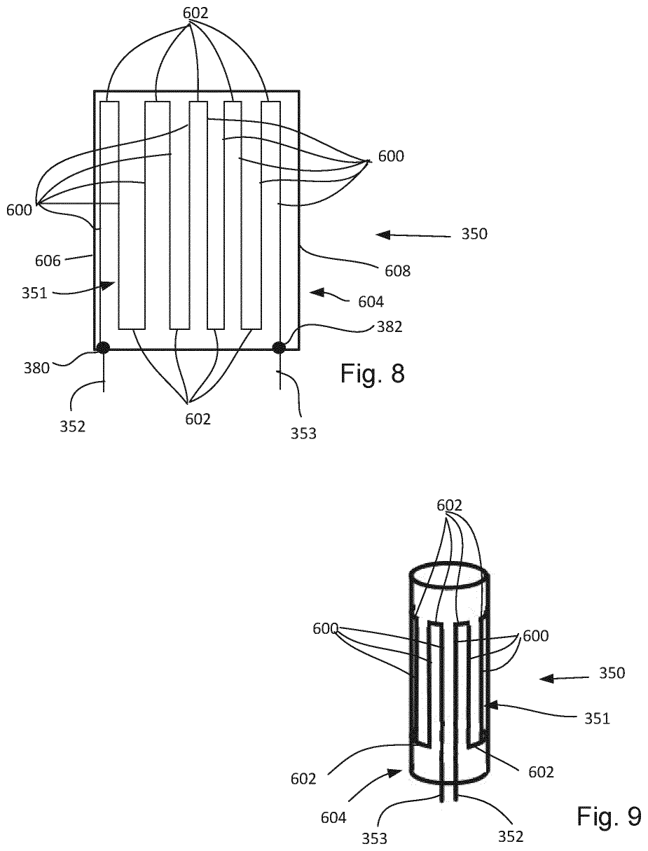

With reference to FIGS. 8 and 9, a second embodiment of the heating element 350 comprises a continuous length of heating material 351 supported on a surface of a substrate 604. The continuous length of heating material 351 follows a serpentine path across the surface of the substrate 604. The continuous length of heating material 351 comprises a resistive member or restive heating material defining the continuous length of heating material 351. In embodiments the continuous length of heating material 351 comprises an electrically insulative coating, such as a ceramic or other dielectric material, to electrically insulate the continuous length of heating material 351 from the elongate housing 302. The electrically insulative coating in embodiments is thermally conductive to provide for heat transfer from the continuous length of heating material 351 to the elongate housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the continuous length of heating material 351 to the elongate housing 302.

The substrate 604 is a flexible electrically insulative material.

The continuous length of heating material 351 is a resistive heater. The continuous length of heating material 351 comprises a plurality of portions 600 of the length and a plurality of intersections 602, the intersections 602 extend between longitudinally (with reference to the center line of the continuous length of heating material 351) adjacent portions 600, and the portions 600 and the intersections 602 alternate along the length of the heating material 351.

In the embodiment shown in FIGS. 8 and 9 each of the portions 600 is straight, and each portion 600 extends approximately in a direction parallel to the longitudinal axis A of the elongate housing 302. Further in the illustrated embodiment, each intersection 602 is a part of the continuous length of heating material 351 that extends between portions 600 that are, in terms of the centerline of the continuous length of heating material 351, longitudinally adjacent to each other. The portions 602 extend at about a 90 degrees angle to the portions 600.

The substrate 604 is formed into a tube as shown in FIG. 9. The substrate 604 is so configured that when formed into the tube of FIG. 9 the edges 608, 608 of the substrate abut or overlap, and the tube is so dimensioned that the tube may sit within the inner void 308 of the housing 302. In some embodiments the surface of the substrate 604 on which the continuous length of heating material 351 is supported is radially outward facing when the substrate 604 is formed into the tube. This causes the portions 600 to be circumferentially spaced from each other around the radially outer face of the tube. In some embodiments the substrate 604 is elastically deformable and the edges 606, 608 of the substrate not fixed to each other when the substrate is formed into a tube. In such an embodiment the tube is placed in the inner void 308 and the elastic nature of the substrate causes the substrate 604 to expand the tube to rest against the surface of the housing 302 that defines the inner void. This assists in creating an efficient heat transfer from the continuous length of heating material 351 to the housing 302.

In some alternative, non-illustrated embodiments, each of the portions 600 are curved, and each portion extends at least partially in a direction parallel to the longitudinal axis A of the elongate housing 302.

In some alternative, non-illustrated embodiments, at least one of the portions 600 is straight, at least one of the portions 600 is curved, and each portion 600 extends at least partially in a direction parallel to the longitudinal axis.

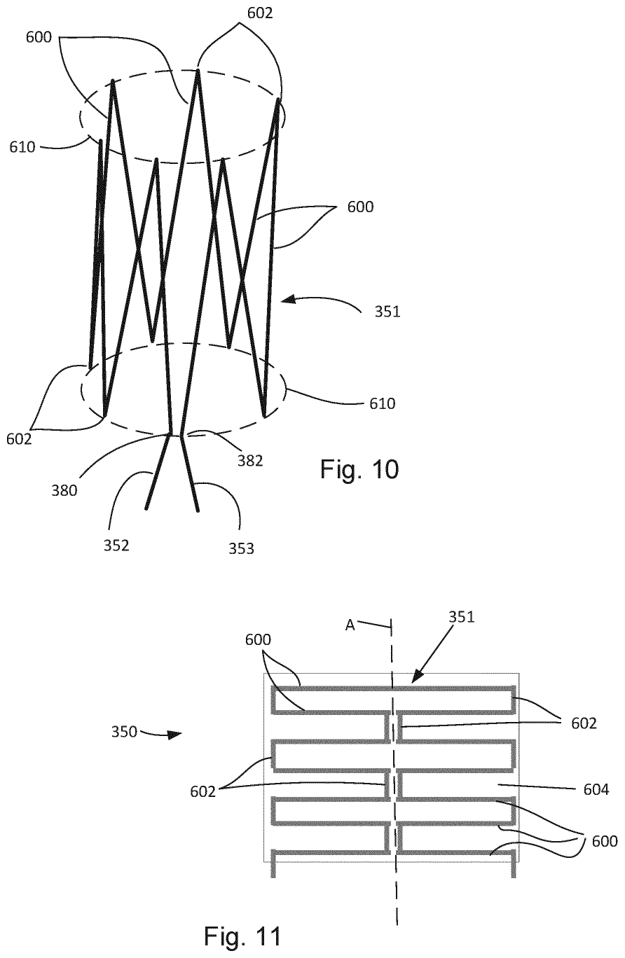

With reference to FIG. 10, a third embodiment of the heating element 350 comprises a continuous length of heating material 351 which follows a serpentine path. The continuous length of heating material 351 comprises a resistive member or restive heating material defining the continuous length of heating material 351. In embodiments the continuous length of heating material 351 comprises an electrically insulative coating, such as a ceramic or other dielectric material, to electrically insulate the continuous length of heating material 351 from the elongate housing 302. The electrically insulative coating in embodiments is thermally conductive to provide for heat transfer from the continuous length of heating material 350 to the elongate housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the continuous length of heating material 350 to the elongate housing 302.

The continuous length of heating material 351 is a resistive heater. The continuous length of heating material 351 comprises a plurality of portions 600 of the length and a plurality of intersections 602, the intersections 602 are the parts of the continuous length of heating material 351 between longitudinally (with reference to the center line of the continuous length of heating material 351) adjacent portions 600, and the portions 600 and the intersections 602 alternate along the length of the heating material 351.

In the embodiment shown in FIG. 10 each of the portions 600 is curved, and each portion 600 extends in a direction that includes a component in a direction parallel to the longitudinal axis A of the elongate housing 302. Further, in the illustrated embodiment, each intersection 602 is the junction between two portions 600 that are, in terms of the centerline of the continuous length of heating material 351, longitudinally adjacent to each other. The included angle between the portions 600 either side of an intersection 602 is less than 45 degrees. In other embodiments the included angle may be greater than zero degrees and less than 90 degrees depending on the desired density of the portions/the overall length of the continuous length of heating material 351.

The continuous length of heating material 351 is so configured that each of the intersections 602 may be considered to be located on one or the other of the virtual circles 610. As a result, the continuous length of heating material 351 may be considered to be approximately located on the surface of a virtual cylinder the ends of which are defined by virtual circles 610. The continuous length of heating material 351 is so dimensioned that the continuous length of heating material 351 in its serpentine path may sit within the inner void 308 of the housing 302.

In some alternative, non-illustrated embodiments, each of the portions 600 are straight, and each portion extends at least partially in a direction parallel to the longitudinal axis A of the elongate housing 302.

In some alternative, non-illustrated embodiments, at least one of the portions 600 is straight, at least one of the portions 600 is curved, and each portion 600 extends at least partially in a direction parallel to the longitudinal axis.

With reference to FIG. 11, a fourth embodiment of the heating element 350 comprises a continuous length of heating material 351 supported on a surface of a substrate 604. The continuous length of heating material 351 follows a serpentine path across the surface of the substrate 604. The continuous length of heating material 351 comprises a resistive member or restive heating material defining the continuous length of heating material 351. In embodiments the continuous length of heating material 351 comprises an electrically insulative coating, such as a ceramic or other dielectric material, to electrically insulate the continuous length of heating material 351 from the elongate housing 302. The electrically insulative coating in embodiments is thermally conductive to provide for heat transfer from the continuous length of heating material 351 to the elongate housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the continuous length of heating material 351 to the elongate housing 302.

The substrate 604 is a flexible electrically insulative material.

The continuous length of heating material 351 is a resistive heater. The continuous length of heating material 351 comprises a plurality of portions 600 of the length and a plurality of intersections 602 (for clarity not all of portions 600 or intersections 602 are labelled), the intersections 602 extend between longitudinally (with reference to the center line of the continuous length of heating material 351) adjacent portions 600, and the portions 600 and the intersections 602 alternate along the length of the heating material 351.

In the embodiment shown in FIG. 11 each of the portions 600 is straight, and each portion 600 extends approximately in a direction perpendicular to the longitudinal axis A of the elongate housing 302. Further in the illustrated embodiment, each intersection 602 is a part of the continuous length of heating material 351 that extends between portions 600 that are, in terms of the centerline of the continuous length of heating material 351, longitudinally adjacent to each other. The portions 602 extend at about a 90 degrees angle to the portions 600.

The substrate 604 of FIG. 11 is formed into a tube to allow it to be inserted into the elongate housing 302 in a similar fashion as described above in connection with FIG. 9.

In the embodiments shown in FIG. 7, FIGS. 8 and 9, FIG. 10 and FIG. 11 the continuous length of heating material 351 has a rectangular cross-sectional profile. It will be understood that other profiles are possible. In embodiments, the continuous length of heating material 351 has a circular cross-sectional profile. In embodiments, the heating arrangement 300 comprises two or more continuous length of heating material 351.

The heating arrangement 300 comprises electrical connection paths 352, 353. The first and second electrical connection paths 352, 353 each extend from a first and second end of the continuous length of heating material 351 respectively. The electrical connection paths 352, 353 are integrally formed with the continuous length of heating material 351, for example as a single wire. In embodiments, connectors 280, 382 connect the electrical connection paths with the continuous length of heating material 351. The continuous length of heating material 351 is formed from a resistive material, such as a nickel/chrome alloy such as nichrome 80/20(80% Nickel, 20% Chromium), an iron/chrome/aluminium alloy, or a copper/nickel alloy.

In the above described embodiments, the heating arrangement is a resistive heating arrangement. In embodiments, other types of heating arrangement are used, such as inductive heating. The configuration of the device is generally as described above and so a detailed description will be omitted.

An inductive heating arrangement comprises various components to heat the aerosol generating material of the article via an inductive heating process. Induction heating is a process of heating an electrically conducting heating member or heater (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating member) suitably positioned with respect to the inductive element. In inductive heating, as compared to heating by conduction for example, heat is generated inside the susceptor, allowing for rapid heating. Further, there need not be any physical contact between the inductive element and the susceptor, allowing for enhanced freedom in construction and application.

In inductive heating heat is generated in the susceptor (heating member) whereas in resistive heating heat is generated in the coil (heating element).

In embodiments, the heating member of the aerosol provision system is a part of the aerosol generating article, rather than being a part of the aerosol provision device. The heating element may be a resistive heating element, for example in the form of the resistive coil described above, which is provided as part of the aerosol generating article. Electrical connections may enable electric current to flow through the resistive heating element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A heater for an aerosol provision device configured to heat an article containing aerosol generating material, in which the heater comprises:
an elongate housing having a longitudinal axis; and
a heating element comprising a continuous length of heating material;
wherein the continuous length of heating material follows a serpentine path.

2. The heater according to claim 1, in which the continuous length of heating material comprises a plurality of portions of the length and a plurality of intersections, the intersections extend between longitudinally adjacent portions, and the portions and the intersections alternate along the length of the heating material.

3. The heater according to claim 2, in which each of the portions is straight, and each portion extends at least partially in a direction parallel to the longitudinal axis.

4. The heater according to claim 2, in which each of the portions is curved, and each portion extends at least partially in a direction parallel to the longitudinal axis.

5. The heater according to claim 2, in which at least one of the portions is straight, at least one of the portions is curved, and each portion extends at least partially in a direction parallel to the longitudinal axis.

6. The heater according to claim 2, in which each of the portions is straight, and each portion extends at least partially in a direction perpendicular to the longitudinal axis.

7. The heater according to claim 2, in which each of the portions is curved, and each portion extends at least partially in a direction perpendicular to the longitudinal axis.

8. The heater according to claim 2, in which at least one of the portions is straight, at least one of the portions is curved, and each portion extends at least partially in a direction perpendicular to the longitudinal axis.

9. The heater according to claim 2, in which at least one intersection is a curved link extending between the longitudinally adjacent ends of adjacent portions of the length of the heating material, and the length of the curved link is less than the length of either of the portions between which the curved link extends.

10. The heater according to claim 2, in which at least one intersection is comprised of a straight link extending between the longitudinally adjacent ends of adjacent portions of the length of the heating material, and the length of the straight link is less than the length of either of the portions between which the straight link extends.

11. (canceled)

12. The heater according to claim 2, in which at least one intersection is so configured that the included angle between the projected longitudinal axes of the part of the longitudinally adjacent portions that intersect the intersection which is between the adjacent portions is one of greater than or equal to 0 degrees and less than or equal to 45 degrees, and greater than 45 degrees and less than or equal to 90 degrees.

13. The heater according to claim 2, in which each intersection has the same configuration, and optionally each intersection is so configured that the included angle between the projected longitudinal axes of the part of the longitudinally adjacent portions that intersect the intersection which is between the adjacent portions is one of 0 degrees, 45 degrees and 90 degrees.

14. (canceled)

15. The heater according to claim 1, in which the continuous length of heating material is an electrically resistive material, and the heater is a resistive heater.

16. The heater according to claim 1, in which the housing has a base end and a free end, and the free end is configured to penetrate the article containing aerosol generating material.

17. The heater according to claim 16, in which the continuous length of heating material has a first and second end, the intersection longitudinally closest to the first end of the continuous length of heating material and the intersection longitudinally closest to the second end of the continuous length of heating material are both closer to the free end of the housing than the base end of the housing.

18. The heater according to claim 16, in which the housing defines a longitudinally extending bore, the base end of the housing defines an open end of the bore, and at least a part of the continuous length of heating material is located within the bore.

19. (canceled)

20. The heater according to claim 1, in which the heater further comprises at least one mass of a material, and the at least one mass is so configured that retains at least part of the continuous length of heating material in a fixed position relative to the housing, and optionally the mass of material is so configured that the whole of the continuous length of heating material is retained in a fixed position relative to the housing.

21. An aerosol provision device configured to heat an article containing aerosol generating material comprising a heater according to claim 1.

22. An aerosol provision system comprising a heater according to claim 1 and an article comprising aerosol generating material.

23. A method of generating aerosol comprising: providing an aerosol provision device comprising a heater according to claim 1 and a heating chamber including a receiving portion; and at least partially inserting an aerosol generating article into the receiving portion of the heating chamber.
